(19) United States
(12) Patent Application Publication
(10) Pub. No.: US 2005/0170853 A1
(43) Pub. Date: Aug. 4, 2005

(54) System and method for locating mobile communication terminals

(75) Inventors: Charu Verma, Darien, IL (US); Kamal K. Verma, Darien, IL (US); Mariana Benitez Pelaez, Naperville, IL (US); Victoria Marie Halsell, Aurora, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/768,320

(22) Filed: Jan. 30, 2004

(51) Int. Cl. H04M 1/00

(52) U.S. Cl. 455/456.6; 455/433

(57) ABSTRACT

A method of locating a mobile communications terminal is provided. The method includes determining that a predetermined amount of the main battery power is depleted, and switching the terminal to a reserve mode preventing the terminal from receiving a paging message without entry of a PIN. The mobile communications terminal includes a controller for switching the terminal to the reserve mode after a predetermined amount of the main battery power is depleted and alerting means for indicating receipt of an incoming call after receiving a paging message in the reserve mode. The terminal can be located by making a call to the terminal, entering the PIN and then listening for the alert.

The present invention relates to telecommunications, and more particularly to a system and method of locating wireless mobile communications terminals.

Mobile communications terminals, also known as cellular phones or mobile phones, can provide communication over a wireless communications network also known as a cellular network. In order to provide wireless operation, a rechargeable battery is typically used to supply power to the mobile communications terminal. However, a battery can only supply a limited amount of power before the battery power is depleted.

Mobile communications terminals are often small and therefore, they can be easily misplaced. One way to locate a mobile communications terminal which has been misplaced nearby is to make a call to the terminal and listen for the alert also known as the ring. However, a terminal which was turned on when lost will continue to consume battery power until it is depleted and the terminal becomes inoperable. The inoperable terminal cannot be located by simply calling it.

Furthermore, all incoming calls received by the mobile terminal will activate the alert and further deplete the battery which may be near depletion. If the owner is not looking for the mobile terminal and therefore not nearby, the alert will not be heard and will not help locate the device.

It is desirable to provide a system and method for locating a mobile communications terminal when the terminal's battery is near depletion.

### SUMMARY OF THE INVENTION

In accordance with a first aspect of the invention, a method of locating a mobile communications terminal is provided. The method includes determining that a predetermined amount of the main battery power is depleted, and switching the terminal to a reserve mode preventing the terminal from receiving a paging message without entry of a PIN. The terminal can be located by making a call to the terminal, entering the PIN and then listening for the alert.

In accordance with a second aspect of the invention, a mobile communications terminal is provided. The mobile communications terminal includes a controller for switching the terminal to the reserve mode after a predetermined amount of the main battery power is depleted and alerting means for indicating receipt of an incoming call after receiving a paging message in the reserve mode.

In accordance with another aspect of the invention, a system for wireless communications is provided. The system includes a mobile communications terminal having a controller for switching the terminal to a reserve mode and alerting means for indicating receipt of an incoming call after receiving a paging message. The system also includes a wireless communications system element for sending the paging message after entry of the PIN.

### BRIEF DESCRIPTION OF THE DRAWINGS

The invention may take form in certain components and structures, preferred embodiments of which will be illustrated in the accompanying drawings wherein:

FIG. 1 is a block diagram illustrating the invention;

FIG. 2 is a block diagram illustrating a mobile communications terminal in accordance with the invention;

FIG. 3 is a flow chart illustrating steps of the invention;

FIG. 4 is a message flow diagram illustrating the invention;

FIG. 5 is a message flow diagram illustrating the invention; and

FIG. 6 is a message flow diagram illustrating the invention.

### DETAILED DESCRIPTION OF THE INVENTION

Referring to FIG. 1, a portion of a wireless communications network is shown generally at 10. The wireless communications network 10 can be any suitable known wireless communications network including but not limited to CDMA, GSM, etc. A wireless communications network provider (not shown), also known as the service provider, provides the services of the wireless communications network to subscribers. A subscriber can communicate over the wireless communications network 10 using a mobile communications terminal 12. The mobile communications terminal 12, can be capable of sending and/or receiving various media such as data, text, special applications, video, etc., as well as provide voice communications. Examples can include, but are not limited to, CDMA, 3GPP and 3GPP2 terminals, or any other mobile communications terminals capable of providing communications over the wireless communications network 10.

The wireless communications network 10 includes a base station 14 communicating with the mobile communications terminal 12 over an air interface 16. The wireless communications network 10 also includes one or more Call Session Managers (CSM) 18 which can be any one or more wireless network elements capable of handling at least a portion of the call sessions. The CSM 18 can handle at least a portion of functions which can include, but is not limited to, call set-ups, registration and call routing to/from the mobile communications terminal 12. Examples of the CSM 18 can include, but are not limited to, an Internet Protocol Multimedia Subsystem (IMS) for 3GPP wireless networks, or a Mobile Switching Center (MSC) for CDMA wireless networks. The CSM 18 can be a home CSM 18a for the mobile communications terminal 12, or a serving CSM 18b which handles the call sessions control messaging for the mobile communications terminal 12 when it is roaming.

The Call Session Manager 18a, 18b can be connected to the base station 14 via a bearer path also known as a bearer channel, shown as dashed line 20. The bearer path 20 is set up in the wireless communications network 10 during conventional calls to carry communications traffic, including voice and/or data communications, between the mobile terminal 12 and other terminals, one of which is shown at 12a, allowing users of the terminals 12, 12a to communicate with each other. Examples of the other terminals 12a can include, but are not limited to, other wireless terminals, Public Switched Telephone Network terminals, Voice over IP terminals, or other terminals capable of communicating with the wireless terminal 12 over the network bearer path 20.

The Call Session Manager 18 is also connected to the base station 14 via a control path, also known as a control channel, shown as solid line 22. The control path 22 carries network system signaling such as control messages between the wireless terminal 12 and other appropriate network elements, and between the network elements themselves, such that call sessions are properly setup, managed and routed. Suitably, Session Initiated Protocol (SIP) and/or other appropriate known protocols are used on the control and bearer paths, one example of which should not be limiting is the known H.248 protocol. The home CSM 18a and serving CSM can also be connected by the bearer path 20 and control path 22.

The wireless communications network 10 also includes a Home Location Register (HLR) 24 for storing control and/or call state information for the wireless terminal 12. The HLR 24 can also store information concerning the services, such as subscription services, which are available to the mobile terminal 12. This information can be associated with each wireless terminal 12 using the terminal's mobile identity number (MIN) or in any other known manner.

The wireless communications network 10 can also include a Voice Mail (VM) system 26. Incoming calls made to the terminal 12 can be forwarded to the voice mail system 26 instead of being sent to the terminal as described below.

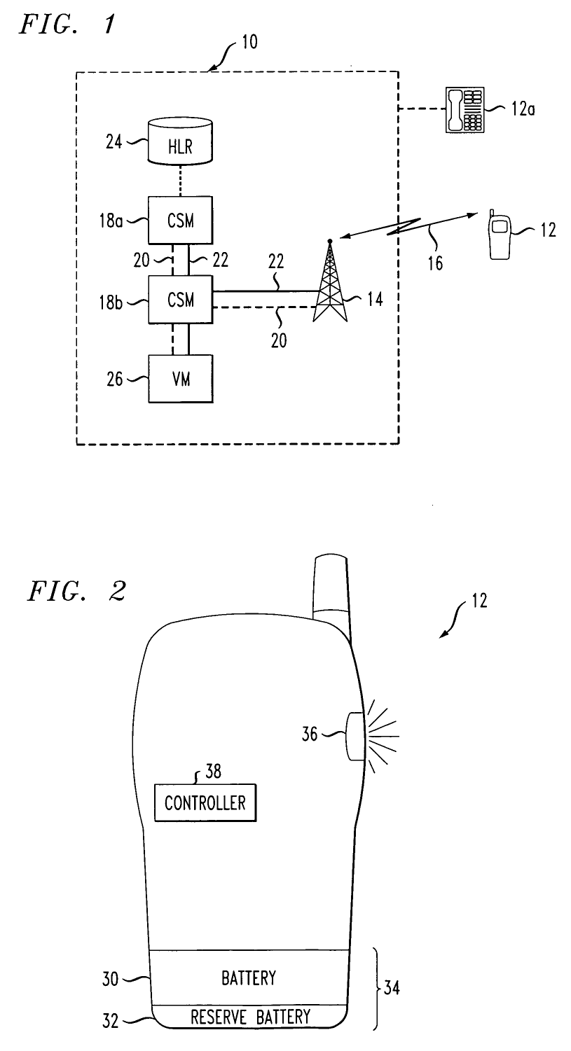

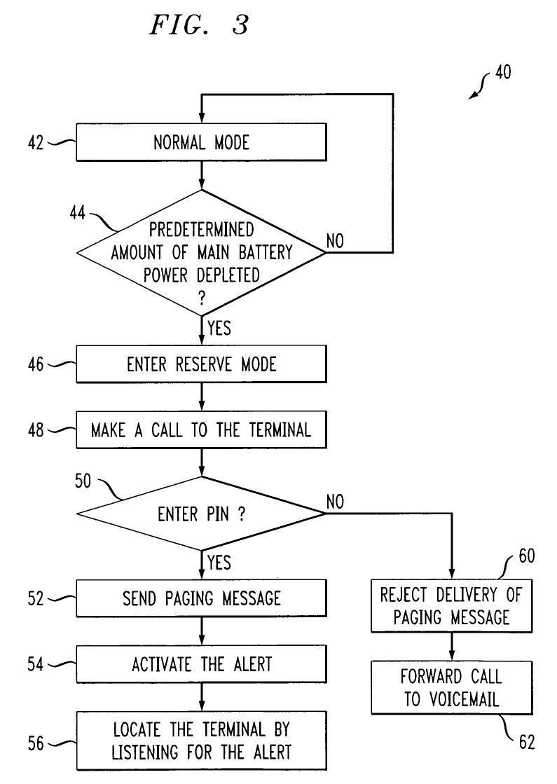

Referring to FIG. 2, the mobile communications terminal 12 includes a main battery 30 for providing main battery power to the terminal in a normal mode. The main battery 30 can be rechargeable. In the normal mode, the terminal 12 has full functionality including the ability to make and receive calls over the wireless communications network 10 and the ability to alert to the receipt of an incoming call, as well as a full complement of other known features. The features can include, but are not limited to providing a display, lighting keys, providing keypress indicators such as tones, and any other known features provided by known mobile communications terminals which can consume the main battery power.

The mobile communications terminal 12 can also include a reserve battery 32 for powering the terminal in reserve mode. The reserve battery 32 can be rechargeable. The reserve battery 32 can be a different battery than the main battery 30. Alternatively, the main battery 30 and the reserve battery 32 can be the same battery, wherein the reserve battery power is provided by the main battery.

The mobile communications terminal 12 also includes alerting means 36 for providing an audible alert indicating that an incoming call is being received by the terminal 12. The alert, also called a ring, can include any desired tone or sound pattern.

The mobile communications terminal 12 also includes a controller 38 for determining that a predetermined amount of power from the main battery is depleted as described below. The controller 38 can determine that the predetermined of the main battery power is depleted in any suitable known manner. The controller 38 switches the terminal 12 from the normal mode to the reserve mode after a predetermined amount of the main battery 30 power is depleted. Examples of the predetermined amount of main battery power depletion can include, but is not limited to approximately 95% to 99%. This value could be provisioned by the network provider and/or the owner of the terminal 12.

In the reserve mode the terminal 12 is prevented from receiving a paging message without entry of a Personal Identification Number (PIN) as described below. The PIN can be any suitable password which is known by the owner/user of the mobile terminal 12 and the service provider, including but not limited to one or more numbers and/or letters. In an alternate embodiment, the terminal 12 in reserve mode can receive a paging message on the control path 22 and activate the alerting means 36 without establishing a bearer path 20 to save battery power as described below.

The mobile communications terminal 12 has reduced functionality while operating in reserve mode to conserve battery power thereby extending the length of time it can be found. Typically, many of the other functions available to the mobile communications terminal 12 operating in normal mode are turned off in the reserve mode to conserve battery power. The functions can include, but are not limited to, lighting a display, indicating incoming caller information, and lighting keys.

Referring to FIG. 3, the operation of the invention shall now be described as the method shown generally at 40. Typically, when the mobile communications terminal 12 is misplaced while turned on, the main battery 30 will continue to discharge. The terminal 12 is usually in normal mode as shown at 42. The controller 38 monitors the main battery power and determines that a predetermined amount of main battery power is depleted at 44.

When a predetermined amount of the main battery power is depleted, the controller 38 switches from the normal mode to the reserve mode at 46. As described above, the controller 38 switches to reserve mode when the main battery power is approximately 95% to 99% depleted.

As described above, the terminal 12 has reduced functionality in reserve mode. The terminal 12 cannot receive a page message without entry of a PIN as described below. In an alternate embodiment, the terminal in reserve mode can receive an incoming page message and provide an alert, such as a ring, for signaling the receipt of an incoming call without establishing a bearer path to save battery power.

The method 40 also includes making a call to the terminal 12 at 48. The user looking for the misplaced terminal 12 calls the phone number of the terminal 12 to make the call. The method 40 also includes determining whether a PIN is entered at 50. The PIN can be entered with the phone used to make the call at 48. The PIN is required in order to send the page message to the terminal as described below thereby activating the alert. Requiring a PIN in reserve mode preserves battery power by preventing conventional calls made without a PIN entry from activating the alert and depleting the battery power. Therefore, the limited battery power can be saved and only used to activate the alert when the user is ready to locate the terminal by listening for it.

The method 40 also includes activating the alerting means 36 in the terminal 12 at 52 if the PIN was entered at 50. The method also includes locating the terminal at 54 by listening for the alert. As stated above, the alert can be the ringer indicating that an incoming call is being received by the terminal 12.

The method 40 can also include rejecting the delivery of the paging message to the terminal 12 at 60 as described below if no PIN is entered at 50. Without the entry of the PIN, the paging message does not reach the terminal 12 and the terminal's alerting means do not alert. This can save the battery power in reserve mode by not ringing the alert for calls not made by the owner. The incoming call can be forwarded to the voicemail system 26 at 62.

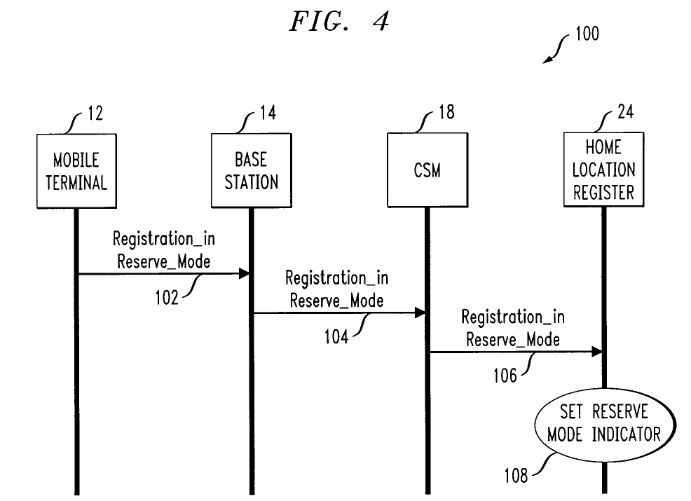

Referring now to FIG. 4, a call flow diagram illustrating call control messages generated when the mobile terminal 12 enters reserve mode at 46 above is shown generally at 100. Upon entering the reserve mode the mobile terminal 12 registers its location with the HLR 24. The mobile terminal 12 sends a Registration_in_Reserve_Mode message to the Base Station 14 at 102 over the control path 22. The Registration_in_Reserve_Mode message includes a registration message and an indication that the terminal 12 has entered reserved mode. The Base Station 14 accepts the Registration_in_Reserve_Mode message 102 and forwards it to the serving CSM 18b at 104. The serving CSM 18b forwards the Registration_in_Reserve_Mode message to the mobile terminal's HLR 24 at 106. Upon receiving the Registration_in_Reserve_Mode message, the HLR 24 sets a reserve mode indicator, such as a flag, which is associated with the terminal 12 indicating that the mobile terminal has entered the reserve mode at 108.

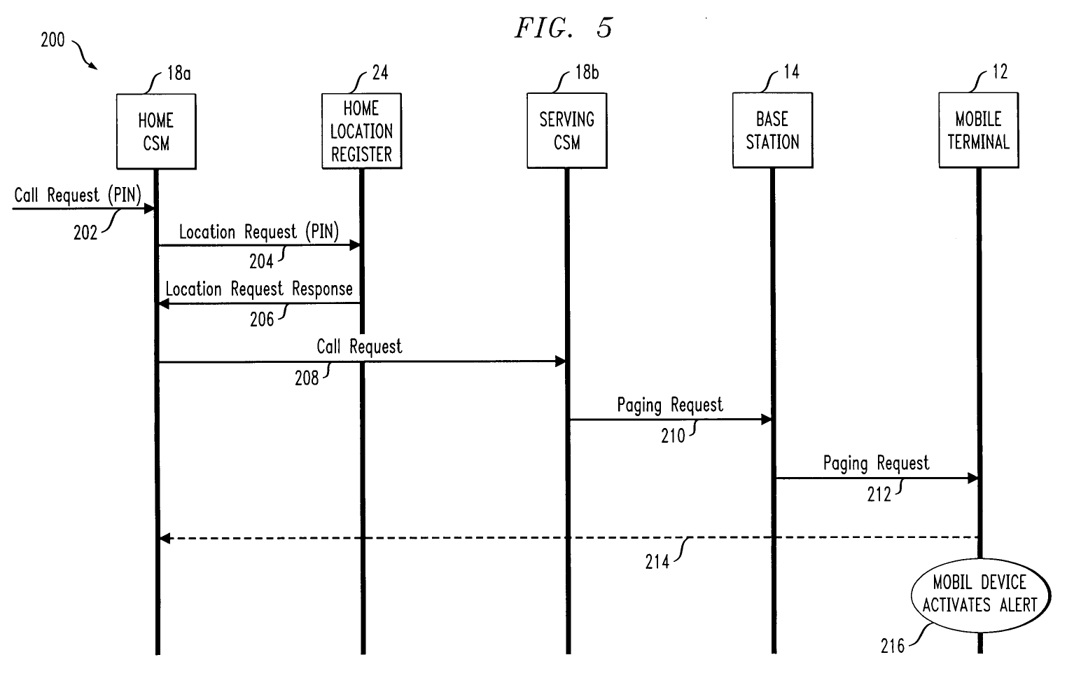

Referring now to FIG. 5, a call flow diagram is shown generally at 200 illustrating call control messages generated on the control path 22 when a call is made from a terminal 12b, at 48 above, to the terminal 12 for locating it in reserve mode and the PIN is entered at 50. A Call_Request message is sent to the home CSM 18a at 202. The Call_Request message includes the PIN information entered at 50 which can be included inside the payload of the message.

The home CSM 18a sends a Location_Request message at 204 to the HLR 24 to determine the location of the mobile terminal 12. The Location_Request message 204 also includes the PIN information which can be included in the payload of the message. The HLR 24 validates the PIN which can be stored in the HLR and associated with the terminal 12 in any suitable known manner.

Upon validating that the correct PIN has been entered, the HLR sends a Location_Request_Response message to the Home CSM 18a at 206 forwarding the location information for the mobile terminal 12. The home CSM 24 forwards the call request to the serving CSM 18b sending it a Call_Request message at 208. The home CSM 18a may be the serving CSM 18b when the mobile terminal 12 is not roaming, in which case, flow 208 is not used.

The serving CSM 18b sends a Paging_Request message to the base station 14 at 210 to page the mobile terminal 12. The base station 14 pages the mobile terminal 12 by sending the Paging_Request message to the mobile terminal at 212.

The mobile terminal 12 receives the page message and establishes a bearer path at 214 in a known manner. The mobile terminal 12 then activates its alert 36 at 216 to indicate the receipt of an incoming call. The owner can listen for the alert to locate the misplace mobile terminal 12.

Establishing the bearer path 20 and communicating over it can consume a large amount of the remaining battery power. Therefore, in an alternate embodiment, after the call is made to the terminal 12 and a PIN is entered, the paging message is sent to the terminal 12 on the control path 22 and the alert is activated as described in FIG. 5 above, but the bearer path 20 is not established at 214. This saves more battery power which can be used to activate the alert. Also, saving battery power by not establishing a bearer path at 214 can extend the amount of time that the terminal 12 can remain in reserve mode. Extending the length of time of the reserve mode can be helpful if the owner of the terminal 12 did not immediately realize that the terminal 12 had been misplaced.

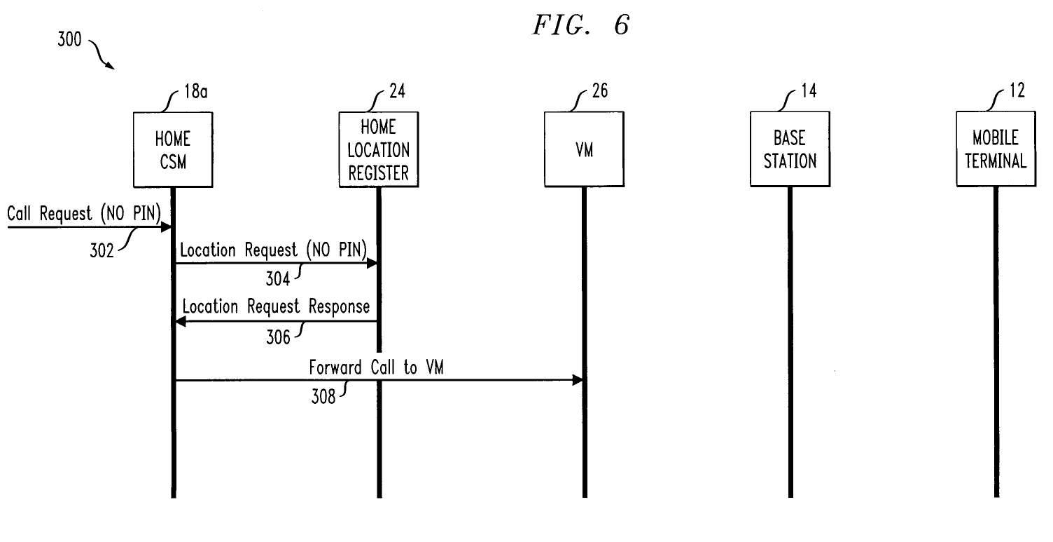

Referring now to FIG. 6, a call flow diagram is shown generally at 300 illustrating call control messages generated on the control path 22 when a call is made from a terminal 12b, at 48 above, to the terminal 12 and no PIN is entered at 50. A Call_Request message is sent to the home CSM 18a at 302. The Call_Request message does not include the PIN information described above. The home CSM 18a sends a Location_Request message at 304 to the HLR 24 to determine the location of the mobile terminal 12. The Location_Request message 304 also does not include the PIN information, and therefore the HLR 24 determines that the PIN was not entered.

Upon determining that no PIN has been entered, the HLR sends a Location_Request_Response message to the Home CSM 18a at 306 indicating that the terminal 12 is in reserve mode which can be used to reject the delivery of the paging message to the terminal 12, thereby not activating the alerting means 36. If an incorrect PIN is entered at 50, the same messaging scheme at 306 can be used to reject the delivery of the paging message to the terminal 12.

The Loctaion_Request_Response message sent at 306 can include a call number set to the voicemail system 26. This message can be used to forward the call to the voicemail system 26. Therefore, incoming calls made by a calling party trying to reach the terminal 12 can be directed to the voicemail system 26 at 308.

The terminal 12 can be automatically returned to normal mode, via the controller 38, when the battery is recharged. The mobile terminal 12 can be reset to normal mode by updating the HLR 24 using a Registration message indicating that the terminal is in normal mode. The Registration message can be sent to the HLR 24 in a manner similar to the Registration_in_Reserve_Mode message sent in FIG. 4. Alternatively, the terminal can be returned to normal mode manually by the user who would activate the controller 38. The terminal could also be returned to normal mode by the network provider using a control message to update the HLR 24 or in any other suitable manner for providing an update to the HLR.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. A method of locating a mobile communications terminal capable of communicating over a wireless communications network and having a main battery, the method comprising:
determining that a predetermined amount of the main battery power is depleted; and
switching the terminal to a reserve mode preventing the terminal from receiving a paging message for an incoming call without entry of a Personal Identification Number (PIN).

2. The method defined in claim 1 wherein the wireless communications network includes a Home Location Register (HLR) and further comprising:
updating the HLR with a reserved mode indicator indicating that the mobile communications terminal has entered reserve mode; and
rejecting the delivery of the paging message to the wireless terminal when a PIN has not been entered.

3. The method defined in claim 2 further comprising;
forwarding the incoming call to a voicemail system.

4. The method defined in claim 1 further comprising:
making a call to the terminal;
entering the PIN;
sending the paging message to the terminal; and
activating an alert at the terminal for indicating receipt of an incoming call.

5. The method defined in claim 4 wherein the paging message is a Paging_Request message.

6. The method defined in claim 1 wherein the predetermined amount of battery power is about 95% to 99%.

7. The method defined in claim 1 further comprising powering the terminal with a reserve battery in the reserve mode.

8. The method defined in claim 4 wherein the activating step includes activating the alert with a reserve battery power.

9. The method defined in claim 1 further comprising:
make a call to the terminal;
entering the PIN;
sending a paging message to the terminal on a control path without subsequently establishing a bearer path; and
activating an alert at the terminal for indicating receipt of an incoming call.

10. A mobile communications terminal comprising:
a main battery for providing power for operating the terminal;
a controller for switching the terminal to a reserve mode after a predetermined amount of the main battery power is depleted thereby preventing the terminal from receiving a paging message without entry of a Personal Identification Number (PIN); and
alerting means for indicating receipt of an incoming call after receiving a paging message in the reserve mode.

11. The mobile communications terminal defined in claim 10 wherein the terminal in reserve mode can receive a paging message on the control channel and activate the alerting means without establishing a bearer path to save battery power

12. The mobile communications terminal defined in claim 10 further comprising:
a reserve battery for providing power to activate the alerting means in reserve mode.

13. The mobile communications terminal defined in claim 10 further comprising:
a reserve battery for powering the terminal in reserve mode, wherein the controller switches the terminal to reserve battery power after a predetermined amount of the main battery power is depleted.

14. A system for wireless communications comprising:
a mobile communications terminal comprising:
a main battery for providing power for operating the terminal,
a controller for switching the terminal to a reserve mode after a predetermined amount of the main battery power is depleted thereby preventing the terminal from receiving a paging message without entry of a Personal Identification Number (PIN), and
alerting means for indicating receipt of an incoming call after receiving a paging message; and
a wireless communications system element for sending the paging message to the mobile communications terminal in reserve mode after entry of the PIN.

15. The system defined in claim 14 wherein the wireless communications system element is an Internet Protocol Multimedia Subsystem.

16. The system defined in claim 14 wherein the wireless communications system element is a Mobile Switching Center.

17. The system defined in claim 14 further comprising a second wireless communications system element, the second wireless communications system element preventing the sending of the paging message to the mobile communications terminal in reserve mode when a PIN is not entered.

18. The system defined in claim 14 wherein the second wireless communications system element is a Home Location Register.

19. The system defined in claim 14 wherein the terminal in reserve mode can receive the paging message on a control path and activate the alerting means without establishing a bearer path to save battery power.

20. The system defined in claim 14 further comprising:
a reserve battery for powering the terminal in the reserve mode, wherein the controller switches the terminal to reserve battery power after a predetermined amount of the main battery power is depleted.
